(19) United States
(12) Patent Application Publication
(10) Pub. No.: US 2013/0326960 A1
(43) Pub. Date: Dec. 12, 2013

(54) ROLLING DEVICE FOR OPENING AND/OR CLOSING A DOOR

(71) Applicant: Friedrich Nikolaus Manseder, Wien (AT)

(72) Inventor: Friedrich Nikolaus Manseder, Wien (AT)

(73) Assignee: ABOTIC GMBH, Wien (AT)

(21) Appl. No.: 14/000,540

(22) PCT Filed: Feb. 28, 2012
(86) PCT No.: PCT/AT12/00044

§ 371 Date: Aug. 20, 2013

(30) Foreign Application Priority Data
Feb. 28, 2011 (AT) 264/2011

(51) Int. Cl. E05F 15/10

(52) U.S. Cl. CPC E05F 15/10
USPC 49/358

(57) ABSTRACT

A rolling device is provided for opening and/or closing a door, having a rolling unit which can be connected to a fastening element to be fastened to the door, by means of a connecting element. The rolling unit has a drive unit which has at least one power accumulator and a drive, and which is connected to a wheel unit that has a drive wheel. The drive wheel, in the mounted operative position of the rolling device, is in frictional contact with a floor surface contiguous to the door. The drive unit together with the power accumulator and the wheel unit are immobilized on the rolling unit, the rolling unit being received so as to be freely mobile under the influence of its proper weight by means of a linear friction bearing formed between the connecting element and the fastening element.

The invention relates to a rolling device for opening and closing a door, comprising a rolling unit that can be connected by a connecting element to a fixing element provided to be mounted on the door, the rolling unit comprising a drive unit which includes at least one energy storage and a drive and is connected to a wheel unit including a drive wheel, the drive wheel being in frictional contact with a bottom surface adjacent to the door, in a mounted operating position of the rolling device.

From AT 508 228 A1 there is known such a device fur the automatic opening and closing of a door, which basically has proven very advantageous when it comes to the barrier-free design of living areas. The device comprises a fixing unit provided to be mounted on a door, wherein a drive unit is arranged. The drive unit comprises an electric motor that drives a drive wheel rolling on the floor. The electric motor is powered by a rechargeable storage battery. The drive wheel is supported in the fixing unit on a bearing base in a height-adjustable manner. So as to press the drive wheel in operation into a frictional contact with the bottom area, a spring is provided between the bearing base and the housing of the fixing unit. Thus, the height-variable support of the drive wheel held in the comparatively light bearing base requires a spring that guarantees the necessary contact pressure on the bottom area. In respect of a simple constructive design, it would be desirable, however, if the frictional contact with the bottom area could be obtained without any such spring elements.

From EP 1 054 129 A1 a different apparatus for opening and closing a door is known, which is arranged by a massive guide bar on a mounting plate fixed to the door leaf. The device comprises a drive without a power supply of its own, which is connected to a drive wheel rolling on the floor. For the height-adjustable support of the drive wheel, the mounting plate comprises three guide rolls, between which the guiding gib is arranged slidably. Thus, a comparatively light-weight drive or roll module is provided, which taken alone can apply only a deficient contact pressure on the floor; so as to guarantee the frictional contact with the floor, in the known device it is therefore necessary that the guide bar be made of massive metal. Such a design, however, involves a complex construction. In addition, the height-adjustable support of the drive wheel via a rolling bearing with guide rolls or castors has the disadvantage that in use any contamination in the region of the guide rolls can cause a tight guiding of the drive wheel, due to which the frictional contact with the bottom surface that is necessary for opening or closing the door may be affected adversely. In addition, in continuous operation, the castors tend to develop noise which is particularly disturbing in the case of using the door opener in interior rooms.

AU 545 753 B further discloses a door opener comprising a rail mounted on the door leaf, in which a corresponding guide plate is slidably supported, on which a wheel unit is mounted. The wheel unit comprises an electric motor that drives the wheel via a transmission. The power supply provided can be an external energy source, a battery or a solar cell. However, it constitutes a disadvantage that the weight of the electric motor alone is not sufficient to reliably guarantee the desired pressure contact of the wheel unit on the floor. So as to help alleviate the problem, the rail of the known door opener comprises a support for a bar mounted on the door, which on its free end is provided with a weight, by means of which the wheel unit is to be pressed against the floor in a sufficiently firm manner. The disadvantage of this design, however, is its very complex construction. Another disadvantage is that the arrangement of the weight on the bar requires a great deal of space, which would be unsuitable for many applications. Finally, it is of disadvantage that an additional connection between the door opener and the door leaf has to be provided, which not only results in higher installation costs but also causes damage to the door leaf.

Further door openers are known from FR 2 871 504 A1, U.S. Pat. No. 1,694,431, GB 785,122 A and AU 2003248440 A1, in which a vertically movable rolling unit is provided.

In contrast thereto, it is the object of the present invention to provide a constructively simple rolling device of the above given type, which is improved in respect of the above stated problems. Accordingly, in particular an autonomous roiling device is to be provided, which has a simple design and ensures a reliable and highly responsive shiftable support of the drive wheel in continuous operation.

This is achieved in the rolling device according to the above given type in that the drive unit including the energy storage and the wheel unit are each mounted on the rolling unit so as to be immovable, the rolling unit being freely slidably supported under the influence of its own weight via a linear slide bearing which in the mounted position is provided between the connecting element and the fixing element.

By connecting the drive unit including the energy storage as well as the wheel unit rigidly with the rolling unit provided to be mounted on the door, the movable mass of the device is considerably increased as compared to a design, in which only the wheel module is movable. Therefore, the rolling unit in particular including the energy storage and the drive unit is freely movably supported under the influence of the own weight in the linear sliding guide, so that additional spring elements or the like for the increase of the contact pressure can be saved. Accordingly, the necessary frictional contact between the wheel and the rolling surface can be obtained via the rolling unit's own weight alone. The use of a massive connecting element is thus no longer absolutely necessary. In addition, the embodiment according to the invention has the advantage that in operation the wheel can be placed on the rolling surface by applying a contact pressure which is essentially independent of the position of the wheel. The contact pressure applied upon the rolling surface is thus independent of the respective profile of the rolling surface. If, for instance, a sloping ramp is provided as bottom surface, the rolling unit is continuously moved along the linear slide bearing during opening or closing the door, in which connection from the start until the end of the opening or closing motion a constant frictional contact exists between the wheel and the ramp-shaped rolling surface. In addition, the linear slide bearing provided between the connecting element of the rolling unit and the fixing element arranged on the door enables a low-friction support of the rolling unit. By means of moving the rolling unit along the linear slide bearing a sensibly responding tracking along the profile of the rolling surface that can have any ground unevenness, upward inclination, etc. can be obtained. Moreover, the arrangement of the linear slide bearing between the connecting element and the fixing element enables an especially smooth displacement of the rolling unit, turning out to be very reliable in continuous operation. Thus, any functional prior art detriments resulting from tight or sticking castors could be avoided. In addition, the linear slide bearing according to the invention guarantees a low-noise operation, since disturbing operating noises from rotating parts of the bearing can be avoided. So as to keep the sliding friction as low as possible, a low-friction combination of materials of the mutually movable parts of the connection and fixing elements can be chosen.

So as to be able to simply connect the rolling unit to the fixing element already mounted on the door and to remove the rolling unit again from the functional position in case of need—without having to take the fixing element off the door, it is advantageous if the linear slide bearing between the connecting element and the fixing element is designed such that the rolling unit can be detached from the fixing element without any tool. Hence, the rolling unit can be detached by means of simply shifting the rolling device from the mounted operating position into a release position, in which the engagement between the bearing means of the linear slide bearing is detached.

In a preferred embodiment of the rolling device for opening and closing the door, it is provided that the rolling unit is essentially vertically movable in the mounted operating position of the rolling device. Depending on the profile of the bottom surface, in operation, displacement of the guide means of the linear slide bearing takes place perpendicularly to the bottom surface or at an inclination angle, thus obtaining a free height adjustment of the rolling unit under its own weight.

So as to arrange the bearing means of the linear slide bearing on the rolling unit or on the fixing element, it is favorable if the linear slide bearing comprises at least one guide carriage arranged on the connecting element, which is movable along a corresponding guide rail arranged on the fixing element. Accordingly, the guide carriage of the rolling unit can be moved along the guide rail so as to be adjusted in height. The guide carriage is preferably designed as a connecting element of the rolling unit and the guide rail is designed as a fixing element. This design enables an especially simple assembly of the device, in which a single guide rail is mounted on the door, which is connected to the corresponding guide carriage of the rolling unit. In contrast to known embodiments, in which two separate guiding gibs are mounted on the door, it is additionally advantageous that no complex adjustment of the guide rail is necessary on the door leaf. Another advantage is that the function of the linear slide bearing is relatively little susceptible to warpage, thus guaranteeing a permanently reliable guiding of the rolling unit. In a less preferred embodiment, however, a reverse arrangement of guide carriage and guide rail on the fixing element and the connecting element, respectively, would be conceivable.

In order to obtain a low-friction and simultaneously stable guiding of the guide carriage along the guide rail, it is favorable if the guide rail comprises a guiding gib encompassed by a corresponding retaining groove of the guide carriage.

The guiding gib preferably comprises an essentially circular cross-section, the respective retaining groove of the guide carriage in particular having an essentially circular or circular-sector-shaped cross-section. A clearance in the form of recesses of the retaining groove can be configured between the guiding gib and the guide carriage, so as to form comparatively small-area contact surfaces between the guide carriage and the guiding gib. A very low sliding friction can be achieved thereby, so that advantageously lubrication of the sliding surfaces is not necessary, thus enabling a dirt-insusceptible and thus low-maintenance operation is possible. In an alternative, less preferred embodiment, the guiding gib may have an essentially square or rectangular cross-section.

When the guide rail has two lateral guiding gibs, on which at least one guide carriage, preferably at least two guide carriages spaced apart from one another can move, an especially stable design can be achieved, which reliably withstands lateral forces particularly occurring during operation. Expediently, the guiding gibs are arranged on the two longitudinal edges of the fixing element, between which the rolling unit is shiftable. In an alternative embodiment only a single central guiding gib is provided, which may be centrally arranged on the fixing element. If for each guiding gib at least two guide carriages are provided, which are spaced apart from one another in the direction of the sliding movement, a particularly weight-saving arrangement can be obtained without compromising the stability.

So as to modify the appearance of the door as little as possible when the rolling unit is detached from the door, it is favorable if the guide rail is designed as an essentially plate-shaped fixing element, which can be arranged along its main extension plane on the door leaf. The plate-shaped fixing element comprises a guiding gib preferably on each of the two longitudinal edges, which for establishing the linear slide bearing is accommodated in a corresponding retaining groove of at least one guide carriage. In the preferred use of a thin-walled mounting plate it is in particular also conceivable to equip all existing doors with such fixing elements that are connected to a rolling device, if necessary. So as to mount the fixing element on the door leaf, a bolted joint or a residue-free glued joint is provided.

For the optional automatic opening or closing of the door the drive wheel can be driven by the driving unit. An electric motor is expediently provided as a drive, which is connected to an accumulator for the power supply. In addition, a sensor unit as well as at least one control unit can be allocated to the drive unit in order to selectively initiate an automatic opening or closing of the door, in particular when a person is approaching the door. In addition, the rolling device can comprise a control element or an interface, on which e. g. various operating modes of the rolling device and the communication with a variety of in particular radio-controlled control devices or remote controls can be adjusted.

The invention will now be described in more detail in a non-limited way, on the basis of embodiments shown in the drawings.

The following will be shown in detail in the drawings:

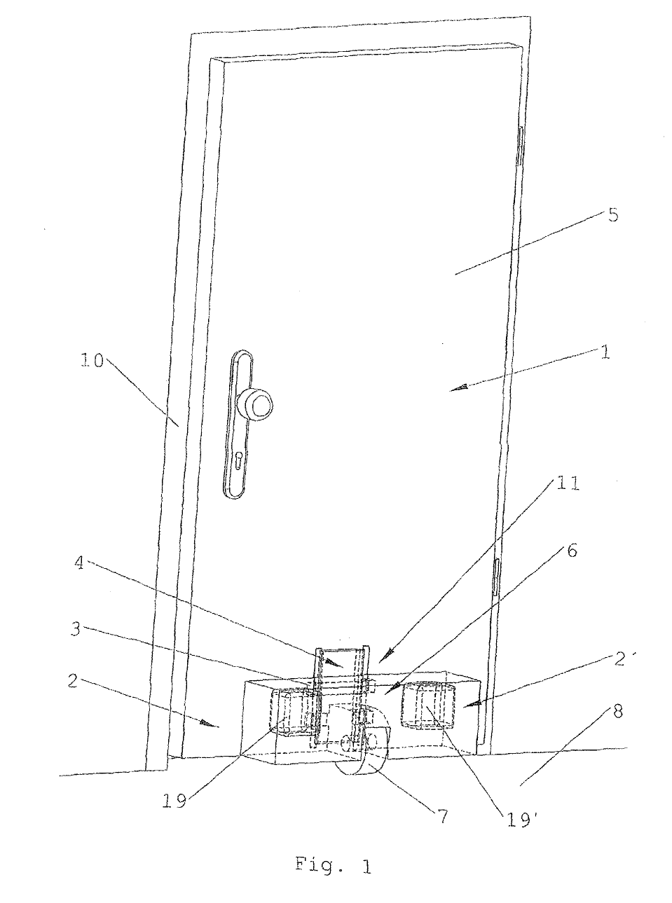

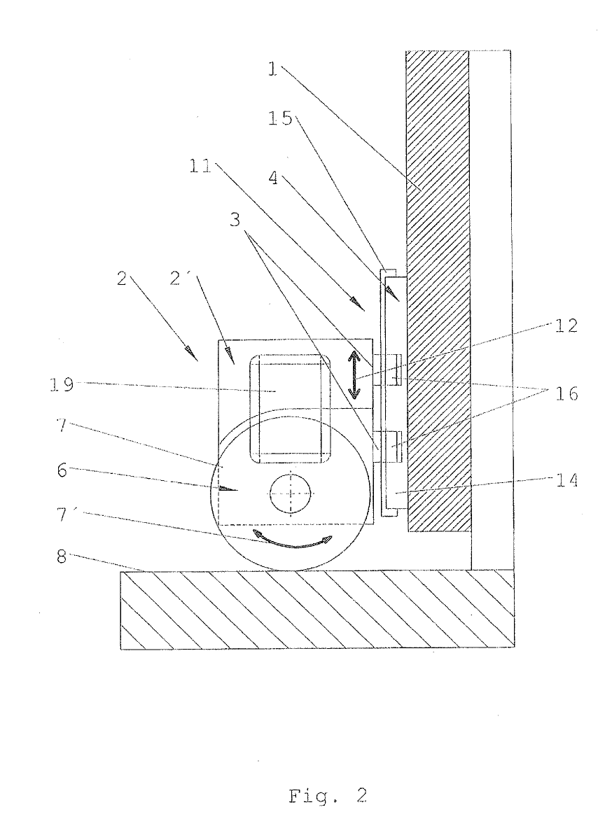

FIG. 1 is a schematic view of a rolling device according to the invention, which is mounted on a pivotable door;

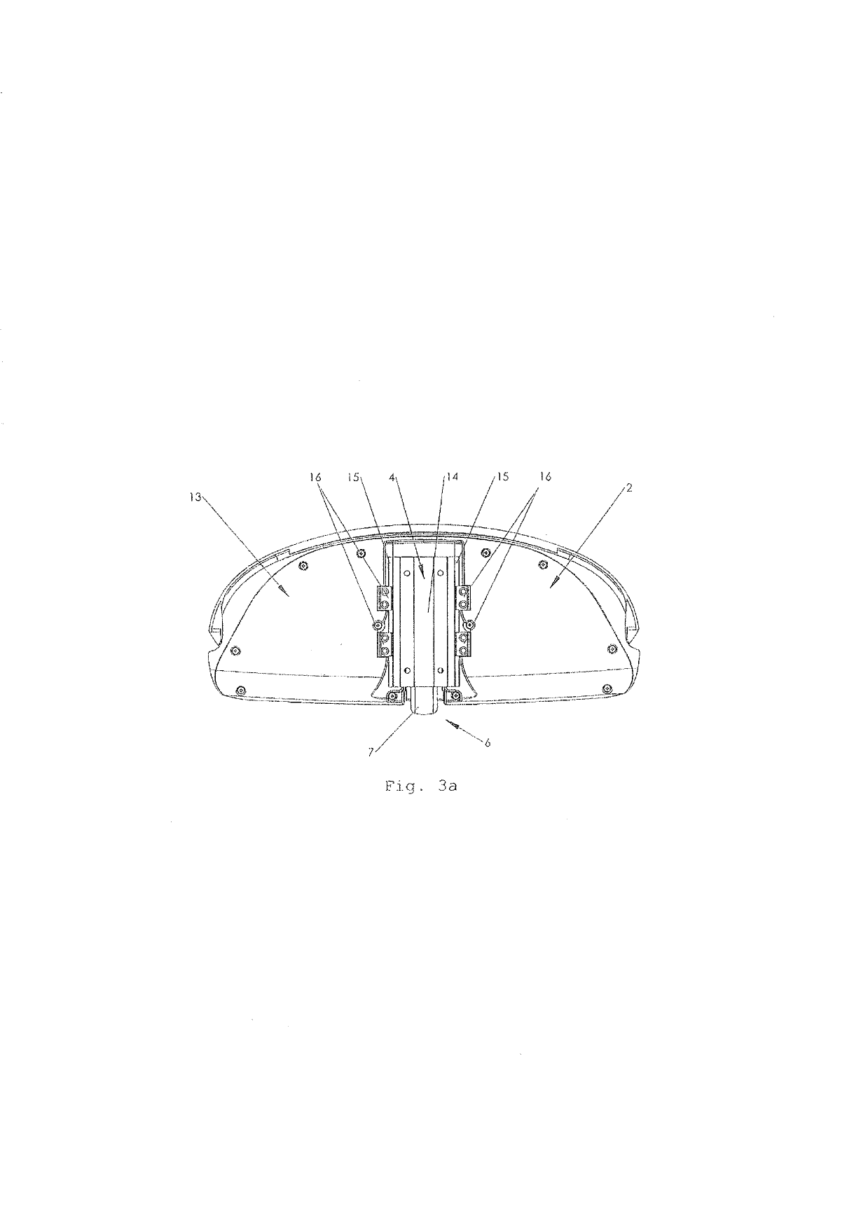

FIG. 2 is a schematic view of the rolling device shown in FIG. 1;

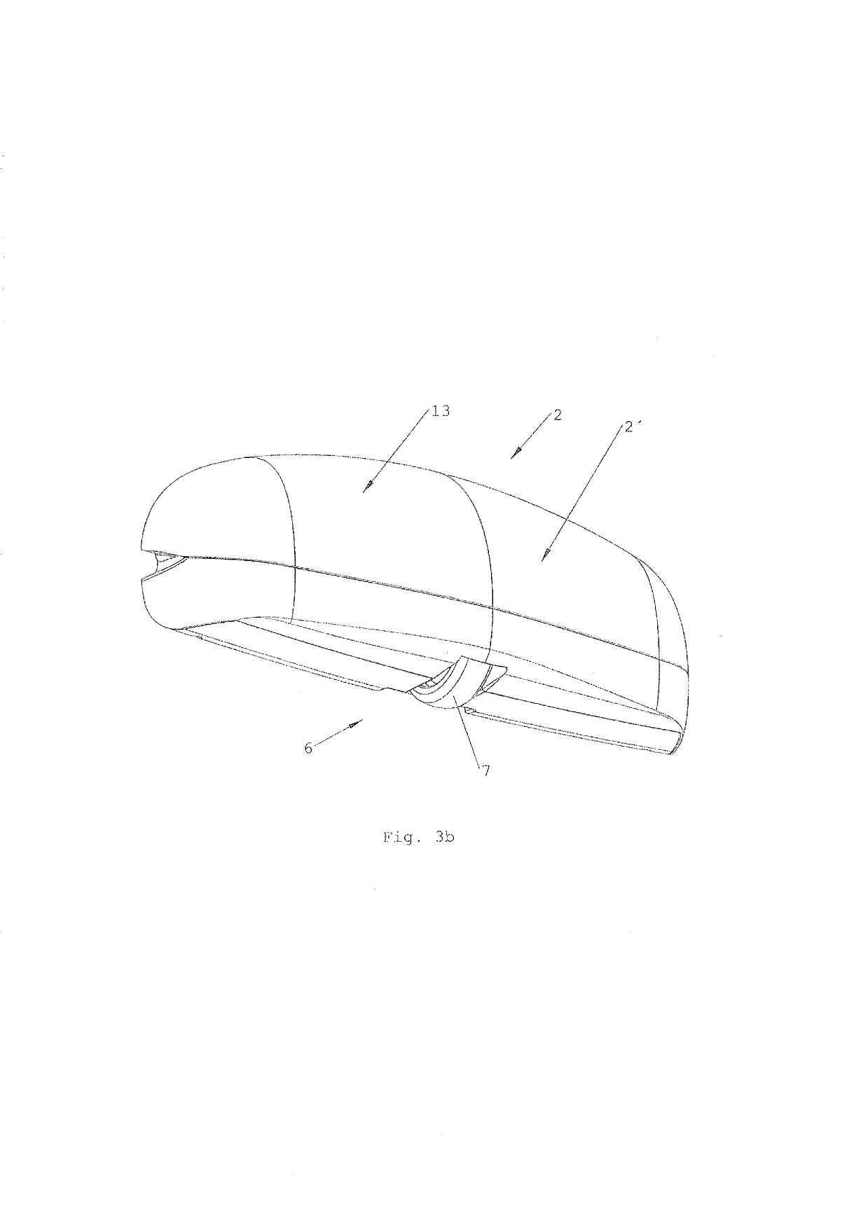

FIGS. 3a and 3b are each a diagram of the rolling device according to FIGS. 1 and 2; and

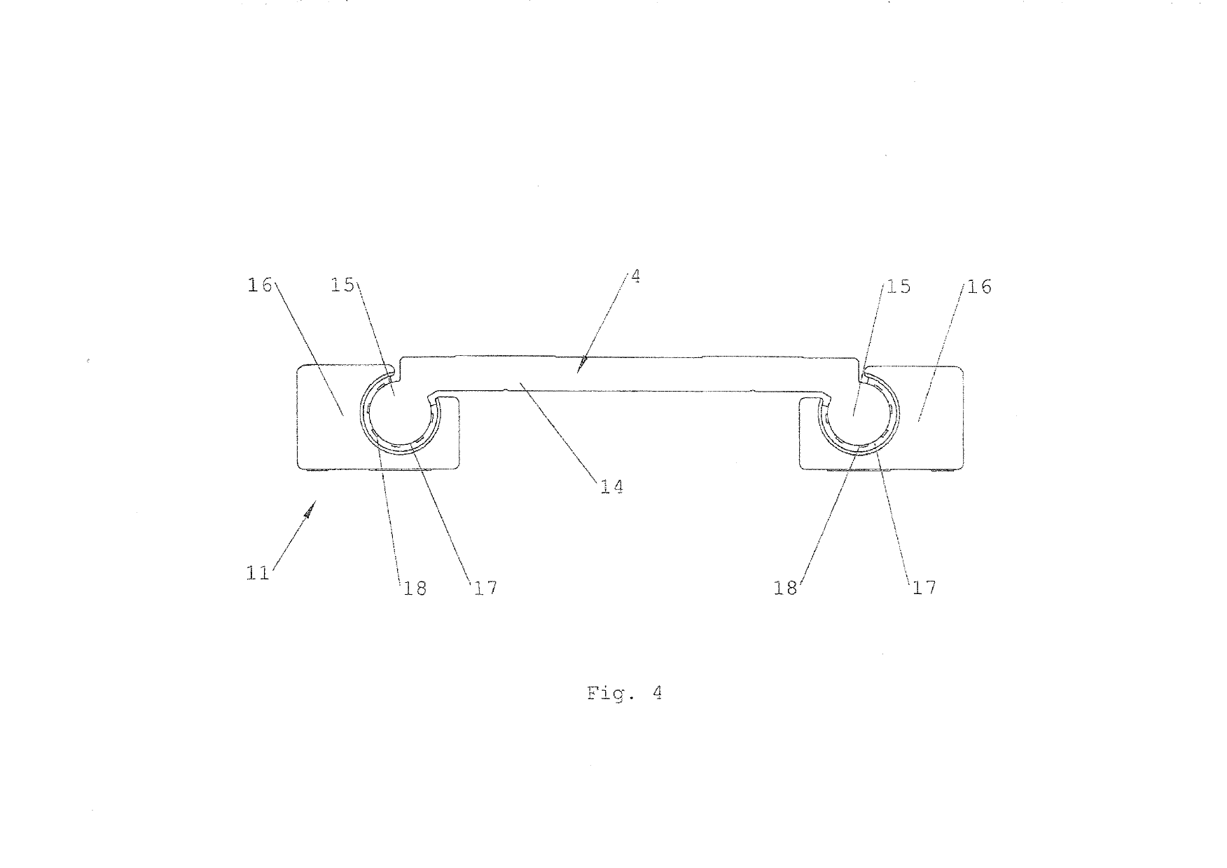

FIG. 4 is a sectional view of a linear slide bearing for the slidable support of the rolling device according to FIGS. 1 to 3.

FIG. 1 shows a pivotably supported door, in the bottom area of the door 1 a rolling device 2 being arranged, which is arranged for the optional opening or closing of the door 1. The rolling device 2 comprises a rolling unit 2′ that is detachably connected by a connecting element 3 to a fixing element 4 connected to a door leaf 5 of the door 1. In an outer housing 13 shown only schematically (cf. FIG. 3), the rolling unit 2′ comprises a drive unit including at least one drive (not shown) as well as at least one energy storage 19 (according to FIG. 1 an additional second energy storage 19′ is provided). A rechargeable accumulator is expediently provided as energy storage 19 or 19′, which supplies the drive, in particular an electric motor with power. The drive unit is connected to a wheel unit 6 comprising a drive wheel 7 rotatably supported in the direction of the arrow 7′, which is in frictional contact with a bottom surface 8 adjacent to the door leaf 5 of the door 1. In the driven state, the drive wheel 7 transmits a torque via the bottom surface 8 onto the door 1, which thereby is swiveled about its swivel axis. Furthermore, the rolling device 2 can include an interface (not shown in the Figures) that is arranged for the communication with radio-controlled control devices, in particular. For instance, remote controls, proximity sensors, etc. can be provided as control devices to automatically initiate an opening or closing operation in the case of a person approaching or moving away.

So as to guarantee the frictional contact between the drive wheel 7 and the bottom surface 8 during opening or closing the door 1, the drive wheel 7 is supported in a height-adjustable manner relative to the bottom surface 8. In most cases so far this has been achieved by means of a light wheel module which, by means of the dynamic effect of a spring, was fixed vertically movably on the immovable housing of the rolling device 2 accommodating the drive.

As can be seen from FIG. 2, in the rolling device 2 according to the invention it is provided that the drive unit and the wheel unit 6 are each fixed on the rolling unit 2′ immovably; the rolling unit 2′—including the drive unit fixed therein and the wheel unit 6—is freely movably supported via a linear slide bearing 11, under the influence of its own weight. So as to form the linear slide bearing 11, the connecting element 3 and the fixing element 4 each comprise suitable bearing means that are movable relative to each other (cf. FIGS. 3, 4). In operation, the drive wheel 7 is thus guided along the respective course of the bottom surface 8 by moving the entire rolling unit 2′ in accordance with the height direction. The rigid coupling of the rolling unit 2′ to the wheel unit 6 and the drive unit causes a comparatively high own weight of the rolling unit 2′ resting upon the drive wheel 7. Thereby, the frictional contact necessary for transmitting torque onto the bottom surface 8 can be guaranteed without any additional springs or the like. In addition, a constant frictional contact between the drive wheel 7 and the bottom surface 8 can be achieved during the opening or closing process, since the contact pressure of the drive wheel 7 on the bottom surface 8 is independent of the respective height position of the drive wheel 7.

As can also be seen from FIG. 2, the rolling unit 2′ is essentially vertically slidably arranged via the guide means of the linear slide bearing 11, which means can be moved against each other in the direction of the arrow 12. In the shown plane bottom surface 8, the shifting via the linear slide bearing 11 is carried out essentially perpendicularly to the bottom surface 8.

As can be seen from FIGS. 3a and 3b, the rolling device 2 comprises a multi-part housing 13, in which the wheel unit 6 and the drive unit are mounted. In addition, a transmission, a coupling, control devices, communication devices and sensors may be arranged in the housing 13.

FIG. 3a shows the rolling device 2 together with the fixing element 4 (not part of the rolling device 2) which is provided as a plate-shaped, single-piece guide rail 14 that is mounted along its main extension plane on the door leaf 5, in the mounted operating position. Along its longitudinal edges, the guide rail 14 comprises a guiding gib 15 each, which, in the mounted operating position, form the linear slide bearing 11 with the corresponding guide carriage 16 of the rolling device 2. In the shown embodiment, the rolling device 2 comprises two guide carriages 16 per guiding gib, which are spaced apart in the direction of height. In order to start up the rolling device 2, the fixing element 4 in the form of the guide rail 14 is mounted on the door leaf 5, and the rolling device 2′ is inserted in the corresponding guiding gibs 15 of the fixing element 4 via the guide carriage 16. If needed, the rolling device 2 can be moved from its mounted operating position upwards into a release position until the guide carriages 16 will glide off from the guiding gibs 15. Accordingly, the rolling device 2 can be connected to or separated from the fixing element 4 previously attached on the door leaf 5, in a manner without using any tools.

As can be seen from FIG. 4, the guide carriages 16 include a retaining groove 17 encompassing the pertinent guiding gib 15 of the guide rail 14. The guiding gib 15 comprises an essentially circular cross-sectional area, any shifting taking place in contact with the retaining groove 17 having a circular-sector shape cross-section. The retaining groove 17 comprises recesses 18 at regular intervals that form a clearance between the guiding gib 15 and the retaining groove 17. The shown embodiment of the linear slide bearing 11 is advantageously arranged to manage the movable support without any additional sliding means, so as to enable a maintenance-free operation of the rolling device 2. In addition, dispensing with any sliding means renders the linear slide bearing 11 extremely dirt-resistant. The guide rail 14 including the guiding gibs 15 is preferably made of hard-anodized aluminum, as a result of which a low-wear operation and good sliding properties can be achieved on the contact surfaces of the retaining groove 17, in connection with a suitable material, in particular iglidur® J200.

1. A rolling device for opening and closing a door, comprising a rolling unit and a connecting element, wherein the rolling device can be connected by the connecting element to a fixing element provided to be mounted on the door, the rolling device comprising a drive unit which includes at least one energy storage and a drive and is connected to a wheel unit including a drive wheel, the drive wheel, in a mounted operating position of the rolling device, being in frictional contact with a bottom surface adjacent to the door, wherein in that the drive unit including the energy storage and the wheel unit are each immovably mounted on the rolling device, the rolling unit being freely slidably supported under the influence of its own weight via a linear slide bearing which in the mounted operating position is provided between the connecting element and the fixing element, so that in operation the drive wheel can be placed on the rolling surface by applying a contact pressure which is essentially independent of the position of the drive wheel.

2. The rolling device according to claim 1, wherein the linear slide bearing between the connecting element and the fixing element is designed such that the rolling unit can be detached from the fixing element without any tool.

3. The rolling device according to claim 1, wherein the rolling unit is essentially vertically movable in the mounted operating position of the rolling device.

4. The rolling device according to claim 1, wherein the linear slide bearing comprises at least one guide carriage arranged on the connecting element, which is movable along a corresponding guide rail arranged on the fixing element.

5. The rolling device according to claim 4, wherein the guide rail includes a guiding gib encompassed by a corresponding retaining groove of the guide carriage.

6. The rolling device according to claim 5, wherein the guiding gib comprises an essentially circular cross-section, the respective retaining groove of the guide carriage in particular having an essentially circular or circular-sector-shaped cross-section.

7. The rolling device according to claim 5, wherein the guide rail has two lateral guiding gibs, on which at least one guide carriage can move.

8. The rolling device according to claim 4, wherein the guide rail is designed as an essentially plate-shaped fixing element, which can be arranged along its main extension plane on the door.

9. The rolling device according to claim 1, wherein an electric motor is provided as a drive, which is connected to an accumulator for the power supply.

10. The rolling device according to claim 7, wherein the guide rail has two lateral guiding gibs, on which at least two guide carriages spaced apart from one another can move.
